(19) United States
(12) Patent Application Publication
(10) Pub. No.: US 2020/0231278 A1
(43) Pub. Date: Jul. 23, 2020

(54) ENERGY STORAGE COMPONENT DELIVERY SYSTEM

(71) Applicant: INTERNATIONAL BUSINESS MACHINES CORPORATION, Armonk, NY (US)

(72) Inventors: Rasit Onur Topaloglu, Poughkeepsie, NY (US); Barry Linder, Hastings-on-Hudson, NY (US)

(21) Appl. No.: 16/250,551

(22) Filed: Jan. 17, 2019

(51) Int. Cl. B64C 39/02; G08G 5/00; B60L 3/12; H02J 7/00

(52) U.S. Cl. CPC B64C 39/024; G08G 5/0069; H02J 2007/005; H02J 7/0027; H02J 7/0021; B60L 3/12

(57) ABSTRACT

A mobile energy delivery system is provided. The mobile energy delivery system includes an unmanned aerial vehicle (UAV) configured to deliver energy, a controller configured to deploy the UAV responsive to a request and a ground-based, drivable vehicle. The ground-based drivable vehicle includes an energy storage component disposed to store energy for ground-based driving, a controller configured to determine a current energy requirement for the ground-based driving and to issue the request to the controller accordingly and a frame. The frame is configured to accommodate the energy storage component and includes a single entirely smooth uppermost surface. The energy storage component is chargeable by the UAV upon the UAV being deployed by the controller in response to the request and subsequently contacting or entering into an immediate vicinity of the single entirely smooth uppermost surface during the ground-based driving.

### BACKGROUND

The present invention generally relates to energy delivery, and more specifically, to a mobile energy delivery system.

Various devices, such as automobiles and trucks, consume energy during operation. This energy can be stored and distributed in various forms, such as magnetic, mechanical, chemical, electrical, heat exchange, compression exchange, and so forth. For example, a vehicle may operate by drawing energy from spinning flywheels, combusting hydrocarbons, drawing electric current from capacitors and so forth. Eventually, if the energy is not replaced, depletion of onboard energy can render the vehicle inoperable. In some cases, the depletion can be complete whereby the vehicle may have insufficient energy onboard to reach a recharging station and thus will become stranded.

A proposed solution to the problem of battery depletion in electric vehicles has been the notion of inductive or capacitive charging from roadway components. This would require large capital outlays and standardization, however, and would additionally require that clearance between the underside of electric vehicles and the roadway surface be limited.

### SUMMARY

Embodiments of the present invention are directed to a mobile energy delivery system. A non-limiting example of the mobile energy delivery system includes an unmanned aerial vehicle (UAV) configured to deliver energy, a controller configured to deploy the UAV responsive to a request and a ground-based, drivable vehicle. The ground-based drivable vehicle includes an energy storage component disposed to store energy for ground-based driving, a controller configured to determine a current energy requirement for the ground-based driving and to issue the request to the controller accordingly and a frame. The frame is configured to accommodate the energy storage component and includes a single entirely smooth uppermost surface. The energy storage component is chargeable by the UAV upon the UAV being deployed by the controller in response to the request and subsequently contacting or entering into an immediate vicinity of the single entirely smooth uppermost surface during the ground-based driving.

Embodiments of the present invention are directed to a mobile energy delivery system. A non-limiting example of the mobile energy delivery system includes an unmanned ground-based vehicle (UGV) configured to deliver energy, a controller configured to deploy the UGV responsive to a request and a ground-based, drivable vehicle. The ground-based drivable vehicle includes an energy storage component disposed to store energy for ground-based driving, a controller configured to determine a current energy requirement for the ground-based driving and to issue the request to the controller accordingly and a frame. The frame is configured to accommodate the energy storage component and includes an undercarriage. The energy storage component is chargeable by the UGV upon the UGV being deployed by the controller in response to the request and subsequently contacting or entering into an immediate vicinity of the undercarriage during the ground-based driving.

Embodiments of the present invention are directed to a mobile energy delivery system. A non-limiting example of the mobile energy delivery system includes a fleet of unmanned aerial or ground-based vehicles (UAVs or UGVs) respectively configured to deliver energy, a controller configured to deploy one of the UAVs or the UGVs responsive to a request and a ground-based, drivable vehicle. The ground-based drivable vehicle includes an energy storage component disposed to store energy for ground-based driving, a controller configured to determine a current energy requirement for the ground-based driving and to issue the request to the controller accordingly and a frame. The frame is configured to accommodate the energy storage component and includes one or more of a single entirely smooth uppermost surface and an undercarriage. The energy storage component is chargeable by a deployed one of the UAVs or the UGVs upon the deployed one of the UAVs being deployed by the controller in response to the request and subsequently contacting or entering into an immediate vicinity of the single entirely smooth uppermost surface during the ground-based driving or upon the deployed one of the UGVs being deployed by the controller in response to the request and subsequently contacting or entering into an immediate vicinity of the undercarriage during the ground-based driving.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a schematic diagram illustrating a mobile energy delivery system in accordance with embodiments of the present invention;

FIG. 2 is a schematic diagram illustrating components of a controller of the mobile energy delivery system of FIG. 1 in accordance with embodiments of the present invention;

FIG. 3 is an enlarged view of a direct charging operation of the mobile energy delivery system in accordance with embodiments of the present invention;

FIG. 4 is an enlarged view of an inductive or capacitive charging operation of the mobile energy delivery system in accordance with embodiments of the present invention;

FIG. 5 is an enlarged view of a ground-up direct charging operation of the mobile energy delivery system in accordance with embodiments of the present invention;

FIG. 6 is an enlarged view of a ground-up inductive or capacitive charging operation of the mobile energy delivery system in accordance with embodiments of the present invention; and

FIG. 7 is a flow diagram illustrating a method of operating a mobile energy delivery system in accordance with embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, electric vehicles are becoming increasingly common on the roads. Electric vehicles are characterized in that they derive all or most of their motive power from electricity and thus include one or more batteries on-board. While electric vehicles are parked, these batteries can be fully charged but during use the batteries become drained as power is drawn from them. The tendency of electric vehicle batteries to become drained leads to an electric vehicle having well-defined ranges that are often shorter than those of gas-powered vehicles and certainly shorter than routes particular drivers might wish to take. As such, electric vehicles typically need to be stopped and recharged every two to four hours of a long trip.

Turning now to an overview of the aspects of the invention, one or more embodiments of the invention address the above-described shortcomings of the prior art by providing for a system by which electric vehicles do not need to be stopped in order to be recharged. This system includes a fleet of unmanned vehicles that are deployable toward an electric vehicle in order to deliver charge to that electric vehicle while the electric vehicle is being driven. The electric vehicle would be modified to receive the charge from the unmanned vehicle without stopping. This modification would not substantially affect the outward appearance of the electric vehicle.

The above-described aspects of the invention address the shortcomings of the prior art by providing for a mobile energy delivery system is provided. The mobile energy delivery system includes an unmanned aerial or ground-based vehicle that is configured to deliver energy, a controller configured to deploy the unmanned aerial or ground-based vehicle responsive to a request and a ground-based, drivable vehicle. The ground-based drivable vehicle includes an energy storage component disposed to store energy for ground-based driving, a controller configured to determine a current energy requirement for the ground-based driving and to issue the request to the controller accordingly and a frame. The frame is configured to accommodate the energy storage component and includes a single entirely smooth uppermost surface or an undercarriage. The energy storage component is chargeable by the unmanned aerial or ground-based vehicle upon the unmanned aerial or ground-based vehicle being deployed by the controller in response to the request and subsequently contacting or entering into an immediate vicinity of the single entirely smooth uppermost surface or the undercarriage during the ground-based driving.

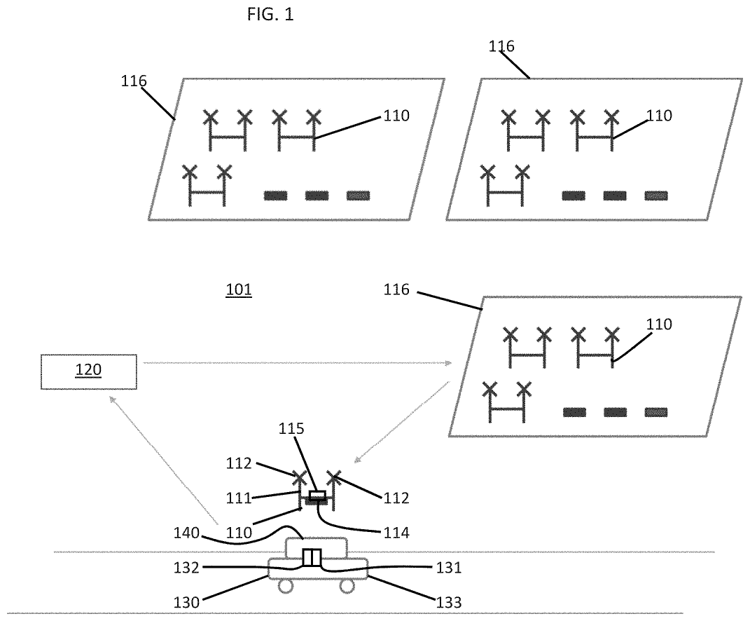

Turning now to a more detailed description of aspects of the present invention, FIG. 1 is a schematic illustration of a mobile energy delivery system 101. The mobile energy delivery system 101 includes a fleet of unmanned aerial vehicles (UAVs) 110 that are each configured to deliver energy, a controller 120 that is configured to deploy each of the UAVs 110 in response to a request in order to fulfill the request with one or more of the deployed UAVs 110 and a ground-based, drivable vehicle 130.

Each UAV 110 includes a body 111, an engine 112 that is accommodated within the body 111 to degenerate power to drive flight operations of the body 111, various controllable flight surfaces that are configured to facilitate controlled flight, a payload 114 that is accommodated within the body 111 and an onboard flight controller 115. The onboard flight controller 115 is configured to autonomously control the engine 112, the controllable flight surfaces and a delivery of the payload 114 in accordance with a predefined flight plan or mission. The onboard flight controller 115 can be communicative with one or both of the controller 120 and the ground-based, drivable vehicles 130.

In accordance with embodiments of the present invention, the UAV 110 is configured with appropriate components to support the delivery of the payload 114 to the ground-based, drivable vehicle 130 during ground-based driving of the ground-based, drivable vehicle 130. As will be described below, the delivery may include inductive or capacitive charging with the UAV 110 disposed at a distance from the ground-based, drivable vehicle 130 or charging by direct contact between the UAV 110 and the ground-based, drivable vehicle 130.

The UAVs 110 can be provided at an initial time as multiple UAVs 110 at various home bases 116. In such cases, the UAVs 110 can each take off from their respective home base 116 and can return to the same or another home base 116, which then becomes the home base 116 for that UAV 110. The home base can be equipped with fueling or charging stations for each UAV 110 that is housed therein.

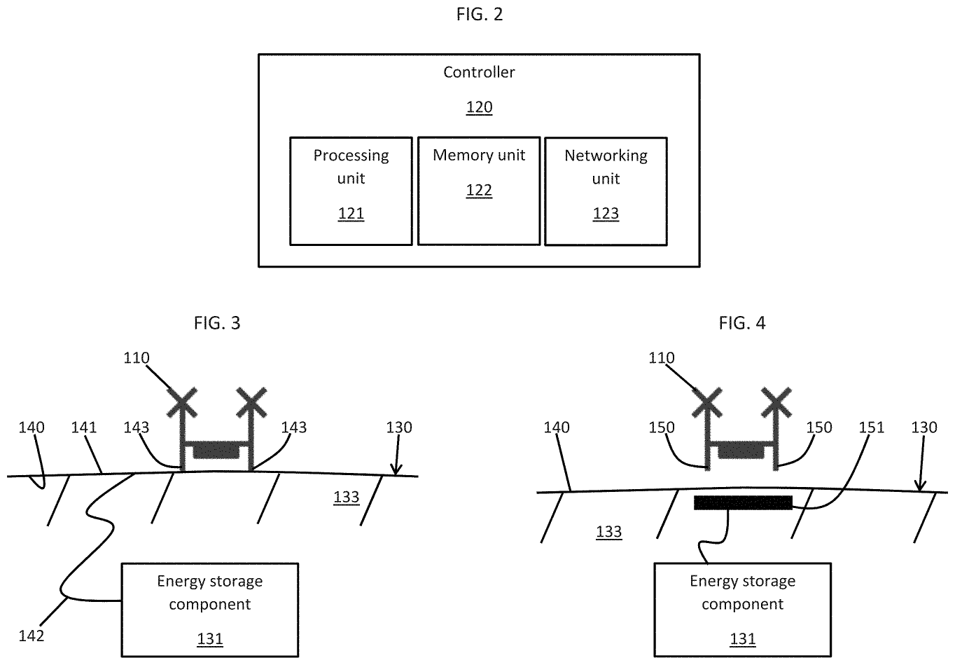

With reference to FIG. 2, the controller 120 can be provided as a local controller, such as a computing work station or server disposed at a home base 116, a distributed controller that is distributed among the processing capacity of the UAVs 110 and the ground-based, drivable vehicle 130 or a cloud controller. In any case, the controller 120 effectively includes a processing unit 121, a memory 122 and a networking unit 123 by which the processing unit 121 communicates with the UAVs 110 and the ground-based, drivable vehicle 130 directly or via a network 123. The memory unit 122 has executable instructions that are readable and executable by the processing unit 121. When the executable instructions are read and executed by the processing unit 121, the executable instructions cause the processing unit 121 to operate as described herein.

In an exemplary case, in an event the ground-based, drivable vehicle 130 issues a request that it be recharged by a UAV 110 as described in greater detail below, the processing unit 121 will receive the request and determine one or more of a location, speed, route and make/model of the ground-based, drivable vehicle 130 from the request. The processing unit 121 will then determine which, if any, of the home bases 116 house a UAV 110 that can answer the request and will assign one of those UAVs 110 accordingly. The processing unit 121 will thus deploy the UAV 110 toward the ground-based, drivable vehicle 130 to answer the request.

With reference back to FIG. 1, the ground-based, drivable vehicle 130 can be provided as an automobile or as an electric car, for example, and includes among other features an energy storage component 131, a controller 132 and a frame 133. The energy storage component 131 can be provided as a battery or, more particularly, as a rechargeable battery and is disposed and configured to store energy for ground-based driving by the ground-based, drivable vehicle 130. The controller 132 can be configured similarly as the controller 120. That is, the controller 132 includes a vehicle processing unit, a vehicle memory unit and a vehicle networking unit. The vehicle processing unit is configured to determine a current energy requirement for the ground-based driving and to issue the request to the controller accordingly.

That is, the vehicle processing unit of the controller 132 determines the current energy requirement by calculating a remaining amount of energy in the energy storage component 131 and an amount of energy required for the ground-based driving and then determines whether the remaining amount of energy in the energy storage component 131 is less than or only slightly larger than the amount of energy required for the ground-based driving. The vehicle processing unit of the controller 132 then issues the request in an event the remaining amount of energy in the energy storage component 131 is indeed less than or only slightly larger than the amount of energy required for the ground-based driving.

The request issued by the vehicle processing unit of the controller 132 can include one or more of a location, a speed, a route and identification (e.g., make/model) information of the ground-based, drivable vehicle 130. This information allows the processing unit 121 of the controller 120 to deploy one of the UAVs 110 from a nearby home base 116 and allows the flight controller 115 of the deployed one of the UAVs 110 to actually execute a controlled flight toward the ground-based, drivable vehicle 130.

Still referring to FIG. 1, the frame 133 is configured in the shape of an automobile, for example, to accommodate at least the energy storage component 131. The frame 133 also includes a single entirely smooth uppermost surface 140. In accordance with various embodiments of the present invention, the energy storage component 131 is chargeable by the deployed one of the UAVs 110 upon the deployed one of the UAVs 110 being deployed by the controller 120 in response to the request and the deployed one of the UAVs 110 subsequently contacting or entering into an immediate vicinity of the single entirely smooth uppermost surface 140 during the ground-based driving of the ground-based, drivable vehicle 130.

The subsequent contact or entry into the immediate vicinity of the single entirely smooth uppermost surface 140 by the deployed one of the UAVs 110 is executed by the flight controller 115 causing the deployed one of the UAVs 110 to substantially match a speed and direction of the ground-based, drivable vehicle 130 at or along a substantially flat and straight roadway.

In greater detail, the flight controller 115 can derive a current position and a route estimate of the ground-based, drivable vehicle 130 from the content of the request and initially fly toward a position at which the deployed one of the UAVs 110 and the ground-based, drivable vehicle 130 would be expected to arrive at around the same time in order to rendezvous with the ground-based, drivable vehicle 130. At this point, the flight controller 115 can refer to the route information and identify a substantially straight a flat section of roadway that the ground-based, drivable vehicle 130 would be expected to traverse. Next, the flight controller 115 can use various sensing equipment on board the deployed one of the UAVs 110 in order to match the speed and direction of the ground-based, drivable vehicle 130 and thus fly onto or in close proximity to the ground-based, drivable vehicle 130.

While some electric vehicles are presently capable of being charged during driving trips via an attachment that is permanently or temporarily affixed to the roof, such attachments are not typically aerodynamic or attractive. As shown in FIG. 2, however, the ground-based, drivable vehicle 130 includes the single entirely smooth uppermost surface 140 to which no attachment ever needs to be attached for charging purposes.

With reference to FIG. 3, the single entirely smooth uppermost surface 140 of the ground-based, drivable vehicle 130 can include conductive paint 141. In this case, the conductive paint 141 can be electrically communicative with the energy storage component 131 by way of electrical leads 142 that are electrically connected to the conductive paint 141 and the energy storage component 131. The energy storage component 131 is thus directly chargeable by the deployed one of the UAVs 110 via the conductive paint 141 and the electrical leads 142 upon leads 143 of the deployed one of the UAVs 110 coming into direct electrical contact with the conductive paint 141 of the single entirely smooth uppermost surface 140.

With reference to FIG. 4, the deployed one of the UAVs 110 and the ground-based, drivable vehicle 130 can each include inductive or capacitive charging leads 150 and 151, respectively. Here, the inductive or capacitive charging leads 151 of the ground-based, drivable vehicle 130 can be secured beneath the single entirely smooth uppermost surface 140 and electrically coupled to the energy storage component 131. In addition, the single entirely smooth uppermost surface 140 can be made of a material which is characterized as having a high transmissivity with respect to inductive or capacitive charging signals between the inductive or capacitive charging leads 150 and 151. The energy storage component 131 is thus inductively or capacitively chargeable by the deployed one of the UAVs 110 upon the inductive or capacitive charging leads 150 of the deployed one of the UAVs 110 coming into the immediate vicinity of the single entirely smooth uppermost surface 140 and the inductive or capacitive charging leads 151 secured beneath the single entirely smooth uppermost surface 140.

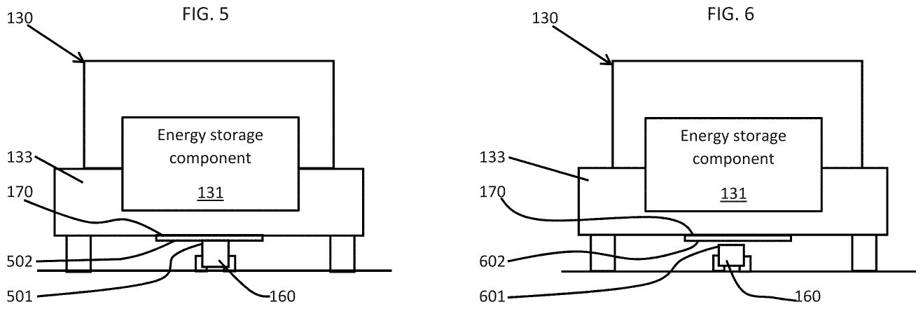

With reference to FIGS. 5 and 6 and, in accordance with additional or alternative embodiments of the present invention, the mobile energy delivery system 101 can include a fleet of unmanned ground-based vehicles (UGVs) 160 in addition to or as replacements for the UAVs 110. In these cases, charging of the energy storage component 131 of the ground-based, drivable vehicle 130 occurs from the ground up and the frame 133 includes an undercarriage 170. As such, the energy storage component 131 is chargeable by a deployed one of the UGVs 160 upon the deployed one of the UGVs 160 being deployed by the controller 120 in response to the request and subsequently contacting the undercarriage 170 during the ground-based driving of the ground-based, drivable vehicle 130 (see the direct charging between leads 501 and 502 of the UGV 160 and the undercarriage 170, respectively, of FIG. 5) or entering into an immediate vicinity of the undercarriage 170 during the ground-based driving of the ground-based, drivable vehicle 130 (see the inductive or capacitive charging between inductive or capacitive leads 601 and 602 of the UGV 160 and the undercarriage 170, respectively, of FIG. 6).

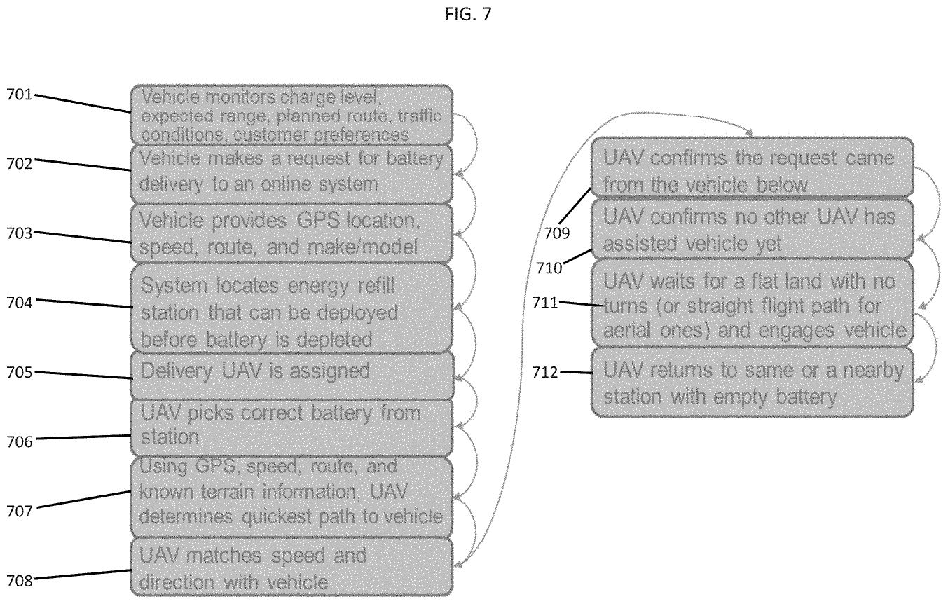

With reference to FIG. 7, a method of operating the mobile energy delivery system 101 is provided and will now be described in general terms.

As shown in FIG. 7, the method initially involves the ground-based, drivable vehicle 130 conducting diagnostics and monitoring charge levels, expected ranges, planned routes, traffic conditions and customer/operator preferences (block 701) and making a request for a battery or charge delivery to the controller 120 (block 702) where the request includes a location, a speed, a routing and identification information of the ground-based, drivable vehicle 130 (block 703). At this point, the controller 120 locates an energy refill station or home base 116 with a UAV 110 or a UGV 160 that can be deployed to answer the request (block 704) and deploys the UAV 110 or the UGV 160 (block 705). The UAV 110 or the UGV 160 loads its payload by, e.g., charging itself or by loading a battery that can be delivered or used to deliver charge (block 706) and determines a path to the ground-based, drivable vehicle 130 (block 707).

The deployed UAV 110 or the deployed UGV 160 then matches a speed and direction with the ground-based, drivable vehicle 130 (block 708) and confirms that the request came from the ground-based, drivable vehicle 130 (block 709) and that no other assistance has been provided or that no other UAV 110 or UGV 160 responded to the request (block 710). This prevents the UAV 110 or the UGV 160 from racing other unmanned vehicles toward the ground-based, drivable vehicle 130 and potentially crashing into those other unmanned vehicles.

At this time, the UAV 110 or the UGV 160 engages with the ground-based, drivable vehicle 130 while the ground-based, drivable vehicle 130 traverses a relatively straight, flat roadway (block 711) in order to provide charging to the ground-based, drivable vehicle 130 and returns to the home base 116 (block 712) once charging is complete. In doing so, the UAV 110 or the UGV 160 is configured to execute a charging operation subject to available UAV 110 or UGV 160 power. That is, the UAV 110 or the UGV 160 only remains with the ground-based, drivable vehicle 130 so long as the UAV 110 or the UGV 160 has sufficient on-board power to return to its original or a new home base 116.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A mobile energy delivery system, comprising:
an unmanned aerial vehicle (UAV) configured to deliver energy;
a controller configured to deploy the UAV responsive to a request; and
a ground-based, drivable vehicle comprising an energy storage component disposed to store energy for ground-based driving, a controller configured to determine a current energy requirement for the ground-based driving and to issue the request to the controller accordingly and a frame configured to accommodate the energy storage component and comprising a single entirely smooth uppermost surface, and
the energy storage component being chargeable by the UAV upon the UAV being deployed by the controller in response to the request and subsequently contacting or entering into an immediate vicinity of the single entirely smooth uppermost surface during the ground-based driving.

2. The mobile energy delivery system according to claim 1, wherein the UAV is one of multiple UAVs of a fleet, each of the multiple UAVs being deployable from and returnable to various home bases.

3. The mobile energy delivery system according to claim 1, wherein the UAV contacts or enters into an immediate vicinity of the single entirely smooth uppermost surface during the ground-based driving by matching a speed and direction of the ground-based, drivable vehicle at a substantially flat and straight roadway.

4. The mobile energy delivery system according to claim 1, wherein:
the controller determines the current energy requirement by calculating a remaining amount of energy in the energy storage component and an amount of energy required for the ground-based driving, and
the controller issues the request in an event the remaining amount of energy in the energy storage component is less than the amount of energy required for the ground-based driving.

5. The mobile energy delivery system according to claim 1, wherein the request comprises location, speed, route and identification information of the ground-based, drivable vehicle.

6. The mobile energy delivery system according to claim 1, wherein:
the single entirely smooth uppermost surface comprises conductive paint which is electrically communicative with the energy storage component, and
the energy storage component is chargeable by the UAV via the conductive paint upon the UAV contacting the single entirely smooth uppermost surface, or
the energy storage component is inductively or capacitively chargeable by the UAV upon the UAV entering into an immediate vicinity of the single entirely smooth uppermost surface.

7. The mobile energy delivery system according to claim 1, wherein the UAV is configured to confirm that the ground-based, drivable vehicle issued the request, that no other UAV responded to the request and executes a charging operation subject to available UAV power.

8. A mobile energy delivery system, comprising:
an unmanned ground-based vehicle (UGV) configured to deliver energy;
a controller configured to deploy the UGV responsive to a request; and
a ground-based, drivable vehicle comprising an energy storage component disposed to store energy for ground-based driving, a controller configured to determine a current energy requirement for the ground-based driving and to issue the request to the controller accordingly and a frame configured to accommodate the energy storage component and comprising an undercarriage, and
the energy storage component being chargeable by the UGV upon the UGV being deployed by the controller in response to the request and subsequently contacting or entering into an immediate vicinity of the undercarriage during the ground-based driving.

9. The mobile energy delivery system according to claim 8, wherein the UGV is one of multiple UGVs of a fleet, each of the multiple UGVs being deployable from and returnable to various home bases.

10. The mobile energy delivery system according to claim 8, wherein the UGV contacts or enters into an immediate vicinity of the undercarriage during the ground-based driving by matching a speed and direction of the ground-based, drivable vehicle at a substantially flat and straight roadway.

11. The mobile energy delivery system according to claim 8, wherein:
the controller determines the current energy requirement by calculating a remaining amount of energy in the energy storage component and an amount of energy required for the ground-based driving, and
the controller issues the request in an event the remaining amount of energy in the energy storage component is less than the amount of energy required for the ground-based driving.

12. The mobile energy delivery system according to claim 8, wherein the request comprises location, speed, route and identification information of the ground-based, drivable vehicle.

13. The mobile energy delivery system according to claim 8, wherein:
the undercarriage is electrically communicative with the energy storage component, and
the energy storage component is chargeable by the UGV upon the UGV contacting the undercarriage, or
the energy storage component is inductively or capacitively chargeable by the UGV upon the UGV entering into an immediate vicinity of the undercarriage.

14. The mobile energy delivery system according to claim 8, wherein the UGV is configured to confirm that the ground-based, drivable vehicle issued the request, that no other UGV responded to the request and executes a charging operation subject to available UGV power.

15. A mobile energy delivery system, comprising:
a fleet of unmanned aerial or ground-based vehicles (UAVs or UGVs) respectively configured to deliver energy;
a controller configured to deploy one of the UAVs or the UGVs responsive to a request; and
a ground-based, drivable vehicle comprising an energy storage component disposed to store energy for ground-based driving, a controller configured to determine a current energy requirement for the ground-based driving and to issue the request to the controller accordingly and a frame configured to accommodate the energy storage component and comprising one or more of a single entirely smooth uppermost surface and an undercarriage, and
the energy storage component being chargeable by a deployed one of the UAVs or the UGVs upon the deployed one of the UAVs being deployed by the controller in response to the request and subsequently contacting or entering into an immediate vicinity of the single entirely smooth uppermost surface during the ground-based driving or upon the deployed one of the UGVs being deployed by the controller in response to the request and subsequently contacting or entering into an immediate vicinity of the undercarriage during the ground-based driving.

16. The mobile energy delivery system according to claim 15, wherein the deployed one of the UAVs or UGVs contacts or enters into an immediate vicinity of the single entirely smooth uppermost surface or the undercarriage during the ground-based driving by matching a speed and direction of the ground-based, drivable vehicle at a substantially flat and straight roadway.

17. The mobile energy delivery system according to claim 15, wherein:
the controller determines the current energy requirement by calculating a remaining amount of energy in the energy storage component and an amount of energy required for the ground-based driving, and
the controller issues the request in an event the remaining amount of energy in the energy storage component is less than the amount of energy required for the ground-based driving.

18. The mobile energy delivery system according to claim 15, wherein the request comprises location, speed, route and identification information of the ground-based, drivable vehicle.

19. The mobile energy delivery system according to claim 15, wherein:
the single entirely smooth uppermost surface comprises conductive paint which is electrically communicative with the energy storage component, and
the energy storage component is chargeable by the deployed one of the UAVs via the conductive paint upon the deployed one of the UAVs contacting the single entirely smooth uppermost surface, or
the energy storage component is inductively or capacitively chargeable by the deployed one of the UAVs upon the deployed one of the UAVs entering into an immediate vicinity of the single entirely smooth uppermost surface.

20. The mobile energy delivery system according to claim 8, wherein:
the undercarriage is electrically communicative with the energy storage component, and
the energy storage component is chargeable by the deployed one of the UGVs upon the deployed one of the UGVs contacting the undercarriage, or
the energy storage component is inductively or capacitively chargeable by the deployed one of the UGVs upon the deployed one of the UGVs entering into an immediate vicinity of the undercarriage.
